(19) United States
(12) Patent Application Publication
(10) Pub. No.: US 2026/0266974 A1
(43) Pub. Date: Sep. 10, 2026

(54) LIDAR, TRANSCEIVER ALIGNMENT METHOD AND SYSTEM THEREFOR

(71) Applicant: AUTOX TECH PTE. LTD., SINGAPORE (SG)

(72) Inventors: Zhuo Li, Shenzhen (CN); Chunting He, Shenzhen (CN)

(73) Assignee: AUTOX TECH PTE. LTD., SINGAPORE (SG)

(21) Appl. No.: 19/257,478

(22) Filed: Jul. 2, 2025

(30) Foreign Application Priority Data
Mar. 7, 2025 (CN) 2025102761202

(51) Int. Cl. G01S 7/497; G01S 7/481

(52) U.S. Cl. CPC G01S 7/4972; G01S 7/4811; G01S 7/4814; G01S 7/4816

(57) ABSTRACT

The disclosure provides a transceiver alignment method for a LiDAR. Includes steps of: selecting a middle channel aligned with the reference emission direction, and first/second edge channels symmetrically disposed vertically; sequentially adjusting receiving plate deflection to peak signal intensities for middle, first edge, and second edge channels; then adjusting emitting plate deflection to re-peak signal intensities for middle, first edge, and second edge channels in sequence. The process employs three symmetric channels (middle and bilateral edges) with iterative dual-plate deflection control, first optimizing receiving plate alignment through sequential edge-to-center peak intensity adjustments, then refining emitting plate alignment using identical sequential peak optimization to achieve transceiver coaxial alignment.

### CROSS REFERENCE TO RELATED APPLICATION

This non-provisional patent application claims priority under 35 U.S. C. §119 from Chinese Patent Application No. 202510276120.2 filed on Mar. 7, 2025, the entire content of which is incorporated herein by reference.

### TECHNICAL FIELD

The disclosure relates to the technical field of LiDAR, and particularly relates to a LiDAR and a transceiver alignment method and system therefor.

### BACKGROUND

A multi-channel LiDAR can simultaneously acquire distance, speed and other information in multiple directions or regions, and is widely used in fields such as autonomous driving, robot navigation, and three-dimensional mapping. In practical applications, the accuracy and reliability of measurement results of a multi-channel LiDAR are affected by factors such as alignment accuracy of multi-channel laser emission and reception. However, existing transceiver alignment technologies mostly rely on complex optical path construction and use of optical components, and the adjustment methods are cumbersome and inefficient.

### SUMMARY

In view of the above, the disclosure provides a LiDAR,, a transceiver alignment method, and system therefor, so as to simply and efficiently realize transceiver alignment of a multi-channel LiDAR.

In a first aspect, the disclosure provides a transceiver alignment method for LiDAR, the LiDAR includes a receiving plate and an emitting plate corresponding to the receiving plate, a plurality of channels being provided between the emitting plate and the receiving plate for transmitting laser beams; the transceiver alignment method for the LiDAR includes steps of: selecting one channel as a middle channel and two channels as a first edge channel and a second edge channel; wherein the middle channel is a channel corresponding to a laser beam emitted from a reference emission direction of the LiDAR, and the first edge channel and the second edge channel are symmetrically distributed on opposite sides of the middle channel in a vertical plane; controlling deflection of the receiving plate to adjust signal intensity of the middle channel to a peak value; controlling deflection of the receiving plate to adjust signal intensity of the first edge channel to a peak value; controlling deflection of the receiving plate to adjust signal intensity of the second edge channel to a peak value; controlling deflection of the emitting plate to readjust signal intensity of the middle channel to a peak value; controlling deflection of the emitting plate to readjust signal intensity of the first edge channel to a peak value; and controlling deflection of the emitting plate to readjust signal intensity of the second edge channel to a peak value.

In a second aspect, the disclosure provides a LiDAR, the LiDAR includes a LiDAR optical engine, an adjustment frame, a rotary table, and a controller; the LiDAR optical engine comprising a receiving plate and an emitting plate corresponding to the receiving plate, a plurality of channels being provided between the emitting plate and the receiving plate for transmitting laser beams; the receiving plate and the emitting plate being fixedly mounted on corresponding adjustment frames respectively, so as to drive the emitting plate or the receiving plate to move and/or rotate along vertical and horizontal directions through the adjustment frames; the receiving plate being provided with a signal acquisition device for acquiring signal intensity of channels; the LiDAR optical engine being mounted on the rotary table; the controller being communicatively connected with the rotary table, the controller controlling movement of the rotary table to drive the LiDAR optical engine to rotate along vertical and horizontal directions; the controller being communicatively connected with the LiDAR optical engine, the controller controlling the LiDAR optical engine to perform channel selection and acquisition of channel signal intensity.

In a third aspect, the disclosure provides a transceiver alignment system for LiDAR, the transceiver alignment system for LiDAR includes the LiDAR described above; a target, arranged at a predetermined distance from the LiDAR; and an image acquisition device, for observing a light spot on the target.

The above LiDAR and transceiver alignment method and system therefor realize calibration of the receiving plate and the emitting plate by adjusting positions of the receiving plate and the emitting plate while detecting a change in signal intensity of channels until signal intensities of the middle channel, the first edge channel, and the second edge channel are all adjusted to peak values, thereby improving accuracy and reliability of measurement results of the LiDAR.

### BRIEF DESCRIPTION OF THE DRAWINGS

To clearly illustrate technical solutions in embodiments of the disclosure or in the prior art, the drawings to be used in the description of the embodiments or the prior art will be briefly introduced below. It is apparent that the drawings described below are merely some embodiments of the disclosure, and for those of ordinary skill in the art, other drawings can be obtained based on the structures shown in these drawings without creative efforts.

FIG. 1 is a flowchart of a transceiver alignment method for LiDAR in accordance with an embodiment.

FIG. 2 is a first sub-flowchart of the transceiver alignment method for LiDAR in accordance with an embodiment

FIG. 3 is a second sub-flowchart of the transceiver alignment method for LiDAR in accordance with an embodiment.

FIG. 4 is a third sub-flowchart of the transceiver alignment method for LiDAR in accordance with an embodiment.

FIG. 5 is a fourth sub-flowchart of the transceiver alignment method for LiDAR in accordance with an embodiment.

FIG. 6 is a structural schematic diagram of a transceiver alignment system for LiDAR in accordance with an embodiment.

FIG. 7 is an electrical connection schematic diagram of a LiDAR in accordance with an embodiment.

FIG. 8 is a schematic diagram of alignment of emission and reception of channels in accordance with an embodiment.

FIG. 9 is a schematic diagram of signal intensity of channels in accordance with an embodiment.

### Reference Numbers in Drawings

LiDAR 100; Target 200; LiDAR Optical Engine 1; Image Acquisition Device 300; Receiving Plate 11; External Light Source R; Emitting Plate 12; Transceiver Alignment System for LiDAR 1000; Adjustment Frame 13; Middle Channel C1; Rotary Table 2; First Edge Channel C2; Controller 3; Second Edge Channel C3; Signal Acquisition Device 4.

The realization of the objectives, functional features, and advantages of the disclosure will be further described below with reference to the embodiments and the drawings.

### DETAILED DESCRIPTION OF THE EMBODIMENTS

In order to make the purpose, technical solution, and advantages of this application clearer and clearer, the following will provide further detailed explanations of this application in conjunction with the accompanying drawings and embodiments. It should be understood that the specific embodiments described here are only intended to explain the present application and are not intended to limit the present application. Based on the embodiments in this application, all other embodiments obtained by ordinary technical personnel in this field without creative labor fall within the scope of protection of this application.

The terms “first,” “second,” “third,” “fourth,” etc. (if present) in the specification, claims, and accompanying drawings of the present application are used to distinguish similar planning objects and are not necessarily used to describe a specific sequence or order. It should be understood that such terms, when used, may be interchangeable under appropriate circumstances. In other words, the described embodiments may be implemented in an order other than that illustrated or described herein. Furthermore, the terms “include” and “have” and any variations thereof may also encompass additional content. For example, a process, method, system, product, or device comprising a series of steps or units is not limited to only those steps or units clearly listed but may include other steps or units not clearly listed or inherent to those processes, methods, products, or device.

It is important to note that the descriptions involving “first,” “second,” etc., in the present application are solely for descriptive purposes and should not be understood as indicating or implying their relative importance or implicitly specifying the number of indicated technical features. Therefore, features qualified by “first,” “second,” etc., may explicitly or implicitly include one or more of such features. In addition, the technical solutions among the various embodiments may be combined with each other, but this must be based on the ability of ordinary skilled artisans in the field to achieve such combinations. When the combination of technical solutions contradicts each other or cannot be implemented, such combinations should be deemed non-existent and not within the scope of protection claimed in the present application.

Referring to FIG. 7, an electrical connection schematic diagram of a LiDAR in accordance with an embodiment. The disclosure further provides a LiDAR 100, the LiDAR 100 includes a LiDAR optical engine 1, a rotary table 2, and a controller 3. The LiDAR optical engine 1 is mounted on the rotary table 2, and the LiDAR optical engine 1 and the rotary table 2 are communicatively connected with the controller 3. The controller 3 controls movement of the rotary table 2 to drive the LiDAR optical engine 1 to rotate along a vertical direction and a horizontal direction, and simultaneously, the controller 3 controls the LiDAR optical engine 1 to perform channel selection and acquisition of channel signal intensity. The specific structure of the LiDAR optical engine 1 will be further introduced below.

The LiDAR optical engine 1 includes a receiving plate 11, an emitting plate 12 corresponding to the receiving plate 11, an adjustment frame 13, and a control circuit (not shown). The receiving plate 11 is provided with a signal acquisition device 4, the signal acquisition device 4 is communicatively connected with the control circuit, and the control circuit is further communicatively connected with the controller 3. The controller 3 controls the LiDAR optical engine 1 to perform channel selection through the control circuit, and controls the signal acquisition device 4 to acquire signal intensity of selected channels. In this embodiment, the signal acquisition device 4 is a SiPM device. The number of the receiving plate 11 and the emitting plate 12 can be one or more, which is not limited herein.

Furthermore, the receiving plate 11 and the emitting plate 12 are fixedly mounted on corresponding adjustment frames 13 respectively, so as to drive the emitting plate 12 or the receiving plate 11 to move and/or rotate along vertical and horizontal directions through the adjustment frames 13. It can be understood that since the emitting plate 12 and the receiving plate 11 are not fixedly mounted on the same adjustment frame 13, but are fixedly mounted on respective adjustment frames 13, the emitting plate 12 and the receiving plate 11 can be adjusted separately. The rotary table 2 is used for centralized adjustment of the emitting plate 12 and the receiving plate 11. In this embodiment, the emitting plate 12 and the receiving plate 11 are fixedly mounted on corresponding adjustment frames 13 by vacuum adsorption or screw locking. In this embodiment, the adjustment frame 13 is a manual adjustment frame 13, that is, an operator manually controls the adjustment frame 13 to adjust the emitting plate 12 or the receiving plate 11. It can be understood that in some other feasible embodiments, the adjustment frame 13 can also be adjusted through a control circuit.

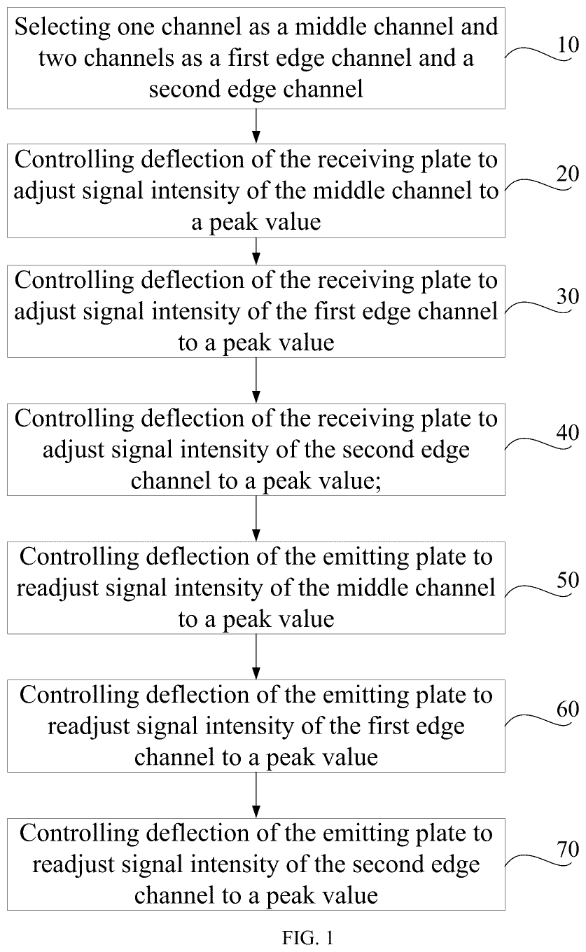

Referring to FIG. 1, a flowchart of a transceiver alignment method for LiDAR in accordance with an embodiment is illustrated. The disclosure provides a transceiver alignment method for LiDAR, applied to a multi-channel LiDAR 100. The transceiver alignment method for LiDAR realizes alignment of an emitting plate 12 and a receiving plate 11 in the LiDAR 100 by detecting a change in signal intensity of channels, thereby improving accuracy and reliability of measurement results of the LiDAR 100. It can be understood that when the number of the receiving plate 11 and the emitting plate 12 is more than one, each emitting plate 12 needs to be aligned with a corresponding receiving plate 11 during installation and adjustment. The transceiver alignment method for LiDAR is complemented by steps S10-S70.

In the step S10: Selecting one channel as a middle channel and two channels as a first edge channel and a second edge channel.

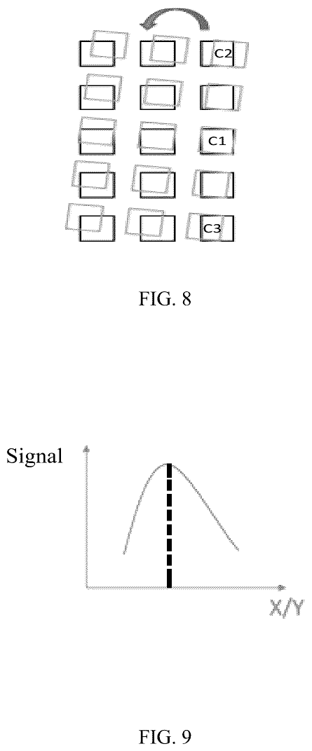

Referring to FIG. 8, a schematic diagram of alignment of emission and reception of channels in accordance with an embodiment is illustrated. In step S10, a plurality of channels are defined between the emitting plate 12 and the receiving plate 11 for transmitting laser beams. Specifically, the controller 3 controls the LiDAR optical engine 1 to select one channel from the plurality of channels as a middle channel C1, and simultaneously selects two channels as a first edge channel C2 and a second edge channel C3. The middle channel C1 is a channel corresponding to a laser beam emitted from a reference direction (i.e., a laser beam emitted at 0° of the LiDAR optical engine) in the LiDAR optical engine 1. The plurality of channels are arranged in a column, and the first edge channel C2 and the second edge channel C3 are two channels located on opposite sides of the middle channel C1 in a vertical direction.

In this embodiment, each channel includes both an emission optical path for emitting a laser beam by the emitting plate 12 and a reception optical path for receiving the laser beam by the receiving plate 11. The more overlapping portions between the emission optical path and the reception optical path of the channel, the stronger the signal intensity of the channel. It can be understood that when the emitting plate 12 and the receiving plate 11 are aligned, emission optical paths and reception optical paths of all channels are completely coincident. In other words, signal intensities of all channels are strongest. The disclosure realizes alignment of the emitting plate 12 and the receiving plate 11 in the LiDAR 100 by adjusting signal intensities of several selected channels to peak values.

Furthermore, the selected channels are several channels with large physical distances. It can be understood that channels with small physical distances have small offset angles, and channels with large physical distances have large offset angles. Therefore, when signal intensities of several channels with large offset angles are all peak values, signal intensities of all channels in the LiDAR optical engine 1 are all peak values. In this embodiment, in order to improve accuracy of debugging results, the first edge channel C2, the second edge channel C3, and the middle channel C1 are selected such that their physical distances are large. Preferably, the first edge channel C2 and the second edge channel C3 are two outermost channels on upper and lower sides of the middle channel C1.

In the step S20: controlling deflection of the receiving plate to adjust signal intensity of the middle channel to a peak value.

Before performing step S20, the controller 3 controls the rotary table 2 to reset, so that the LiDAR optical engine 1 is located at a 0 position (i.e., positions of the LiDAR optical engine 1 in XYZ three directions are aligned to a preset 0 point position). At this time, a theoretical position of the middle channel C1 (a channel corresponding to a beam emitted at 0°) on the target 200 at a preset distance is a center of the target. The disclosure forms a light spot by an external light source R after beam collimation on the theoretical position of the middle channel C1 on the target 200 (i.e., the center of the target). The external light source R is reflected by the target 200 and transmitted to the receiving plate 11 through the middle channel C1. Meanwhile, the image acquisition device 300 is used to observe whether the light spot formed by the external light source R hits the center of the target. In this embodiment, the external light source R is a handheld 905 nm laser light source after collimation.

In the step S20, the controller 3 controls the receiving plate 11 to deflect along horizontal and/or vertical directions, and simultaneously, the controller 3 controls the signal acquisition device 4 to acquire signal intensity of the middle channel C1 to monitor real-time signal intensity variations of the middle channel C1. Specifically, the controller 3 controls the receiving plate to deflect along a horizontal direction until signal intensity of the middle channel C1 in the horizontal direction changes to a peak value, and controls the receiving plate 11 to deflect along a vertical direction until signal intensity of the middle channel C1 in the vertical direction is adjusted to a peak value. It can be understood that the disclosure does not limit the order of controlling the receiving plate 11 to deflect along the vertical direction and controlling the receiving plate 11 to deflect along the horizontal direction.

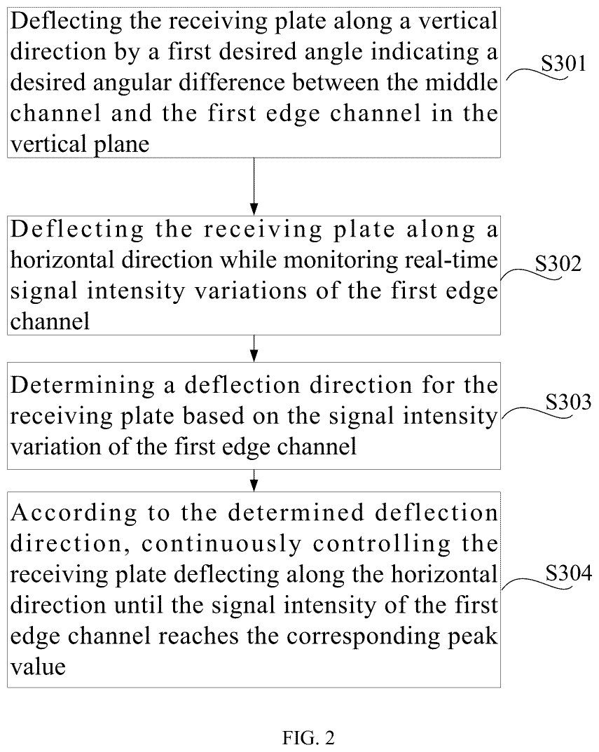

In the step S30: controlling deflection of the receiving plate to adjust signal intensity of the first edge channel to a peak value. Referring to FIG. 2 and FIG. 9, which are a first sub-flowchart of the transceiver alignment method for LiDAR and a schematic diagram of signal intensity of channels in accordance with an embodiment respectively. Step S30 is complemented by the following steps S301-S304.

In the step S301: deflecting the receiving plate along a vertical direction by a first desired angle indicating a desired angular difference between the middle channel and the first edge channel in the vertical plane. In other words, the first desired angle is a theoretical angular difference between the middle channel C1 and the first edge channel C2 in the vertical direction. It can be understood that since the first edge channel C2 and the second edge channel C3 are located on opposite sides of the middle channel C1 in the vertical direction, theoretically, neither the first edge channel C2 nor the second edge channel C3 has a theoretical angular difference with the middle channel C1 in a horizontal direction, but only has a theoretical angular difference in the vertical direction. If the receiving plate 11 is controlled to deflect along the vertical direction by the first desired angle, the first edge channel C2 will move to an original position of the middle channel C1. That is, the theoretical position of the first edge channel C2 on the target 200 will become the center of the target. The external light source R is reflected by the target 200 and transmitted to the receiving plate 11 through the first edge channel C2. However, due to assembly errors of the receiving plate 11, actually, the first edge channel C2 and the middle channel C1 also have a certain offset angle in the horizontal direction. Therefore, after the receiving plate 11 deflects along the vertical direction by the first desired angle, a light spot corresponding to the first edge channel C2 and the center of the target are on a same horizontal line, but do not coincide.

In the step S302: deflecting the receiving plate along a horizontal direction while monitoring real-time signal intensity variations of the first edge channel. Specifically, when the light spot corresponding to the first edge channel C2 and the center of the target are on the same horizontal line, the controller 3 controls the receiving plate 11 to deflect along the horizontal direction, and simultaneously controls the signal acquisition device 4 to acquire signal intensity of the first edge channel C2 to monitor real-time signal intensity variations of the first edge channel C2.

In the step S303: determining a deflection direction for the receiving plate based on the signal intensity variation of the first edge channel. Specifically, the receiving plate is controlled to deflect along the horizontal direction (left or right). If signal intensity of the first edge channel C2 becomes stronger, it indicates that this direction is the deflection direction of the receiving plate 11. If signal intensity of the first edge channel C2 becomes weaker, it indicates that a direction opposite to this direction is the deflection direction of the receiving plate 11.

In the step S304: according to the determined deflection direction, continuously controlling the receiving plate deflecting along the horizontal direction until the signal intensity of the first edge channel reaches the corresponding peak value. Specifically, the controller 3 controls the receiving plate 11 to deflect along a direction where signal intensity becomes larger until signal intensity of the first edge channel is adjusted to a peak value, and controls the receiving plate 11 to stop deflecting. At this time, the light spot corresponding to the first edge channel C2 and the center of the target are also on a same vertical line, that is, the light spot corresponding to the first edge channel C2 coincides with the center of the target. It can be understood that the disclosure realizes preliminary calibration of the receiving plate 11 by calculating the first edge channel C2.

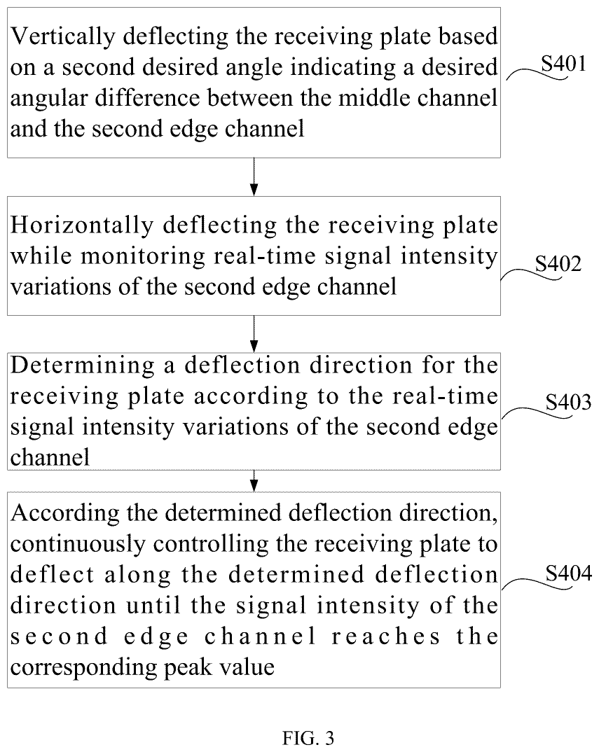

In the step S40: controlling deflection of the receiving plate to adjust signal intensity of the second edge channel to a peak value. Referring to FIG. 3, which is a second sub-flowchart of the transceiver alignment method for LiDAR in accordance with an embodiment. Step S40 is complemented by the following steps S401-S404.

In the step S401: vertically deflecting the receiving plate based on a second desired angle indicating a desired angular difference between the middle channel and the second edge channel. The second desired angle is a theoretical angular difference between the middle channel C1 and the second edge channel C3 in the vertical direction. It can be understood that since the first edge channel C2 and the second edge channel C3 are located on opposite sides of the middle channel C1, the receiving plate 11 needs to deflect along the vertical direction by the first desired angle, and then deflect along the vertical direction by the second desired angle, so that the light spot corresponding to the second edge channel C3 and the center of the target are on a same horizontal line.

In the step S402: Controlling deflection of the receiving plate along a horizontal direction and observing a change in signal intensity of the second edge channel. Specifically, when the light spot corresponding to the second edge channel C3 and the center of the target are on the same horizontal line, the controller 3 controls the receiving plate 11 to deflect along the horizontal direction, and simultaneously controls the signal acquisition device 4 to acquire signal intensity of the second edge channel C3 to monitor real-time signal intensity variations of the second edge channel C3.

In the step S403: determining a deflection direction for the receiving plate according to the real-time signal intensity variations of the second edge channel. Specifically, the receiving plate is controlled to deflect along the horizontal direction (left or right). If signal intensity of the second edge channel C3 becomes stronger, it indicates that this direction is the deflection direction of the receiving plate 11. If signal intensity of the second edge channel C3 becomes weaker, it indicates that a direction opposite to this direction is the deflection direction of the receiving plate 11. It can be understood that the disclosure realizes further calibration of the receiving plate 11 by calculating the second edge channel C3.

In the step S404: according the determined deflection direction, continuously controlling the receiving plate to deflect along the determined deflection direction until the signal intensity of the second edge channel reaches the corresponding peak value. Specifically, the controller 3 controls the receiving plate 11 to deflect along a direction where signal intensity becomes larger until signal intensity of the second edge channel C3 is adjusted to a peak value, and controls the receiving plate 11 to stop deflecting. It can be understood that at this time, the second edge channel C3 and the center of the target are on a same vertical line, that is, the light spot corresponding to the second edge channel C3 coincides with the center of the target.

In the step S50: controlling deflection of the emitting plate to readjust signal intensity of the middle channel to a peak value.

Before the step S50, a laser beam emitted by a laser on the emitting plate 12 is controlled to hit the target 200, and the laser beam is reflected by the target 200 and transmitted to the receiving plate 11. The controller 3 controls the emitting plate 12. Based on this, the controller 3 controls the emitting plate 12 to deflect along a horizontal direction until signal intensity of the middle channel C1 in the horizontal direction changes to a peak value again, and controls the emitting plate 12 to deflect along a vertical direction until signal intensity of the middle channel C1 in the vertical direction is adjusted to a peak value again. It can be understood that the disclosure does not limit the order of controlling the emitting plate 12 to deflect along the vertical direction and controlling the emitting plate 12 to deflect along the horizontal direction.

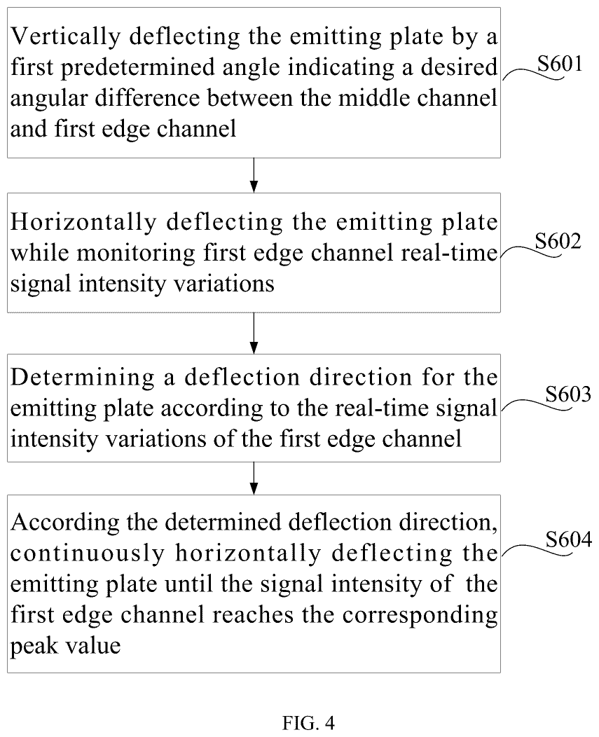

In the step S60: controlling deflection of the emitting plate to readjust signal intensity of the first edge channel to a peak value. Referring to FIG. 4, which is a third sub-flowchart of the transceiver alignment method for LiDAR in accordance with an embodiment. Step S60 is complemented by the following steps S601-S604.

In the step S601: vertically deflecting the emitting plate by a first predetermined angle indicating a desired angular difference between the middle channel and first edge channel. The first desired angle is a theoretical angular difference between the middle channel and the first edge channel in the vertical direction. It can be understood that after the controller 3 controls the emitting plate 12 to deflect along the vertical direction by the first desired angle, the light spot corresponding to the first edge channel C2 and the center of the target are on a same horizontal line, but do not coincide.

In the step S602: horizontally deflecting the emitting plate while monitoring first edge channel real-time signal intensity variations. Specifically, when the light spot corresponding to the first edge channel C2 and the center of the target are on the same horizontal line, the controller 3 controls the emitting plate 12 to deflect along the horizontal direction, and simultaneously controls the signal acquisition device 4 to acquire signal intensity of the first edge channel C2 to monitor real-time signal intensity variations of the first edge channel C2.

In the step S603: determining a deflection direction for the emitting plate according to the real-time signal intensity variations of the first edge channel. A specific scheme is the same as the scheme of determining the deflection direction of the receiving plate according to the change in signal intensity of the first edge channel in step S303, which will not be repeated here.

In the step S604: according the determined deflection direction, continuously horizontally deflecting the emitting plate until the signal intensity of the first edge channel reaches the corresponding peak value. Specifically, the controller 3 controls the emitting plate 12 to deflect along a direction where signal intensity becomes larger until signal intensity of the first edge channel C2 is adjusted to a peak value, and controls the emitting plate 12 to stop deflecting. It can be understood that at this time, the first edge channel C2 and the center of the target are on a same vertical line, that is, the light spot corresponding to the first edge channel C2 coincides with the center of the target.

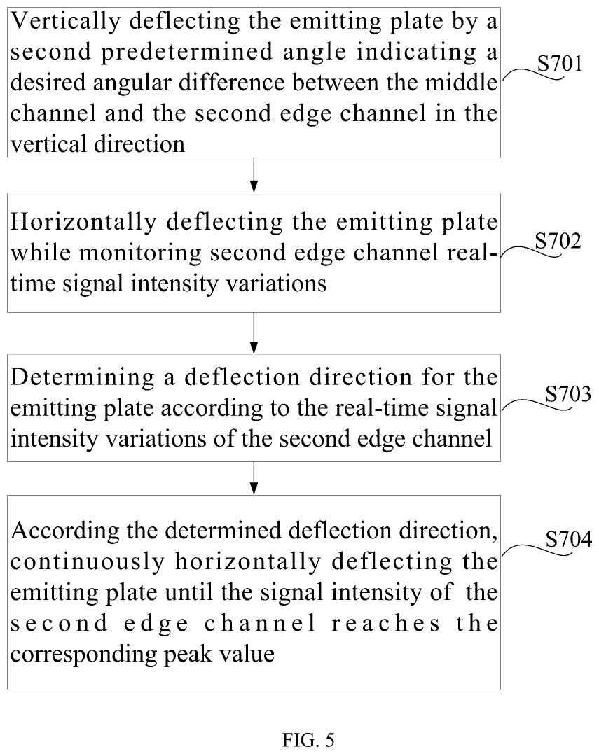

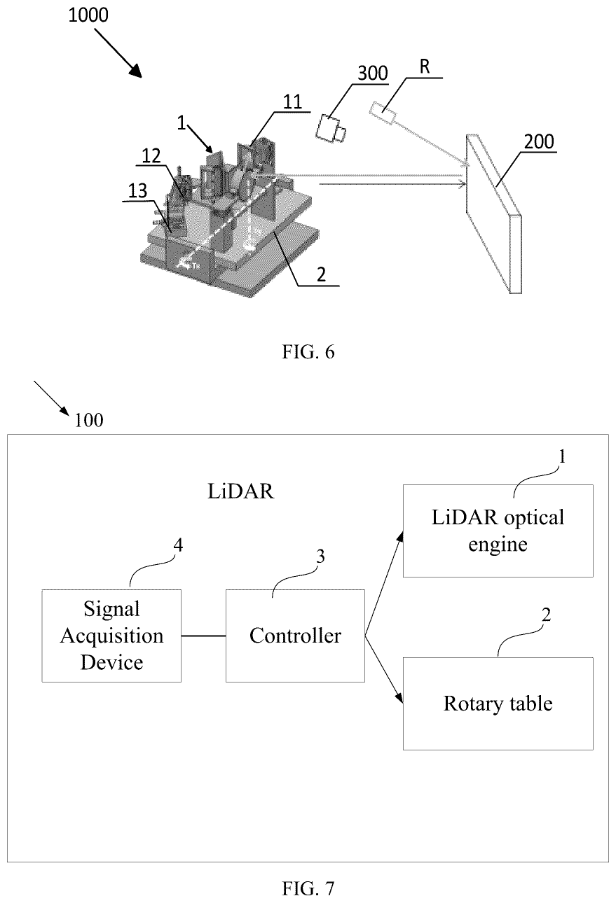

In the step S70: controlling deflection of the emitting plate to adjust signal intensity of the second edge channel to a peak value again. Referring to FIG. 5, which is a fourth sub-flowchart of the transceiver alignment method for LiDAR in accordance with an embodiment. Step S70 comprises the following steps S701-S704.

In the step S701: vertically deflecting the emitting plate by a second predetermined angle indicating a desired angular difference between the middle channel and the second edge channel in the vertical direction. The second desired angle is a theoretical angular difference between the middle channel and the second edge channel in the vertical direction. It can be understood that since the first edge channel C2 and the second edge channel C3 are located on opposite sides of the middle channel C1, the emitting plate 12 needs to deflect along the vertical direction by the first desired angle, and then deflect along the vertical direction by the second desired angle, so that the light spot corresponding to the second edge channel C3 and the center of the target are on a same horizontal line.

In the step S702: horizontally deflecting the emitting plate while monitoring second edge channel real-time signal intensity variations. Specifically, when the light spot corresponding to the second edge channel C3 and the center of the target are on the same horizontal line, the controller 3 controls the emitting plate 12 to deflect along the horizontal direction, and simultaneously controls the signal acquisition device 4 to acquire signal intensity of the second edge channel C3 to monitor real-time signal intensity variations of the second edge channel C3 again.

In the step S703: determining a deflection direction for the emitting plate according to the real-time signal intensity variations of the second edge channel. This determination follows the same methodology outlined in Step S403 and is not elaborated further herein

In the step S704: according the determined deflection direction, continuously horizontally deflecting the emitting plate until the signal intensity of the second edge channel reaches the corresponding peak value. Specifically, the controller 3 controls the emitting plate 12 to deflect along the direction where signal intensity becomes larger until signal intensity of the second edge channel C3 is adjusted to a peak value, and controls the emitting plate 12 to stop deflecting. It can be understood that at this time, the second edge channel C3 and the center of the target are on a same vertical line, that is, the light spot corresponding to the second edge channel C3 coincides with the center of the target.

In the above embodiments, the deflection direction of the emitting plate 12 and the receiving plate 11 can be determined through the first edge channel C2. However, in order to improve accuracy of calibration of the emitting plate 12 and the receiving plate 11, the disclosure further determines the deflection direction of the emitting plate 12 and the receiving plate 11 through the second edge channel C3. It can be understood that in some embodiments, the number of edge channels can be increased or decreased according to actual needs.

In the above embodiments, the external light source R after beam collimation is first hit on the target, and the external light source R is reflected by the target 200 and transmitted to the receiving plate 11, based on which calibration of the receiving plate 11 is performed. After completing calibration of the receiving plate 11, the emitting plate 12 is controlled to emit a laser beam to hit the target, and the laser beam is reflected by the target 200 and transmitted to the receiving plate 11, based on which calibration of the emitting plate 12 is performed.

In the above embodiments, the receiving plate is adjusted through steps S20-S40 until signal intensities of the middle channel, the first edge channel, and the second edge channel are all adjusted to peak values, so as to realize calibration of the receiving plate. The emitting plate is adjusted through steps S50-S70 until signal intensities of the middle channel, the first edge channel, and the second edge channel are all adjusted to peak values again, so as to realize calibration of the emitting plate. Furthermore, in some feasible embodiments, after step S40, step S20 can be returned to again to repeat steps S20-S40, so as to improve accuracy of calibration of the receiving plate. Correspondingly, after step S70, step S50 can be returned to again to repeat steps S50-S70, so as to improve accuracy of calibration of the emitting plate.

Obviously, those skilled in the art can make various modifications and variations to the disclosure without departing from the spirit and scope of the disclosure. Therefore, if these modifications and variations of the disclosure fall within the scope of the claims of the disclosure and their equivalent technologies, the disclosure also intends to include these modifications and variations.

The above listed are only preferred embodiments of the disclosure, and of course, cannot be used to limit the scope of the claims of the disclosure. Therefore, equivalent changes made according to the claims of the disclosure still fall within the scope covered by the disclosure.

1. A transceiver alignment method for a LiDAR, the LiDAR comprising a receiving plate, and an emitting plate corresponding to the receiving plate, a plurality of channels arranged between the emitting plate and the receiving plate for transmitting laser beams; the transceiver alignment method for the LiDAR comprising:
selecting one channel as a middle channel and two channels as a first edge channel and a second edge channel; wherein the middle channel is a channel corresponding to a laser beam emitted from a reference emission direction of the LiDAR, and the first edge channel and the second edge channel are symmetrically distributed on opposite sides of the middle channel in a vertical plane;
controlling deflection of the receiving plate to adjust signal intensity of the middle channel to a peak value;
controlling deflection of the receiving plate to adjust signal intensity of the first edge channel to a peak value;
controlling deflection of the receiving plate to adjust signal intensity of the second edge channel to a peak value;
controlling deflection of the emitting plate to readjust signal intensity of the middle channel to a peak value;
controlling deflection of the emitting plate to readjust signal intensity of the first edge channel to a peak value; and
controlling deflection of the emitting plate to readjust signal intensity of the second edge channel to a peak value.

2. The transceiver alignment method for LiDAR according to claim 1, wherein controlling deflection of the receiving plate to adjust signal intensity of the middle channel to a peak value is complemented by:
controlling deflection of the receiving plate along a horizontal direction until a horizontal direction signal intensity of the middle channel reaches to the corresponding peak value; and
controlling deflection of the receiving plate along a vertical direction until a vertical direction signal intensity of the middle channel reaches to the corresponding peak value.

3. The transceiver alignment method for LiDAR according to claim 1, wherein controlling deflection of the receiving plate to adjust signal intensity of the first edge channel to a peak value is complemented by:
deflecting the receiving plate along a vertical direction by a first desired angle, the first desired angle indicating a desired angular difference between the middle channel and the first edge channel in the vertical plane;
deflecting the receiving plate along a horizontal direction while monitoring real-time signal intensity variations of the first edge channel;
determining a deflection direction for the receiving plate based on the signal intensity variation of the first edge channel; and
according to the determined deflection direction, continuously controlling the receiving plate deflecting along the horizontal direction until the signal intensity of the first edge channel reaches the corresponding peak value.

4. The transceiver alignment method for LiDAR according to claim 3, wherein controlling deflection of the receiving plate to adjust signal intensity of the second edge channel to a peak value is complemented by:
vertically deflecting the receiving plate based on a second desired angle indicating a desired angular difference between the middle channel and the second edge channel;
horizontally deflecting the receiving plate while monitoring real-time signal intensity variations of the second edge channel;
determining a deflection direction for the receiving plate according to the real-time signal intensity variations of the second edge channel; and
according the determined deflection direction, continuously horizontally deflecting the receiving plate until the signal intensity of the second edge channel reaches the corresponding peak value.

5. The transceiver alignment method for LiDAR according to claim 1, wherein deflecting the receiving plate along a horizontal direction while monitoring real-time signal intensity variations of the first edge channel is complemented by:
vertically deflecting the emitting plate by a first predetermined angle indicating a desired angular difference between the middle channel and first edge channel;
horizontally deflecting the emitting plate while monitoring first edge channel real-time signal intensity variations;
determining a deflection direction for the emitting plate according to the real-time signal intensity variations of the first edge channel; and
according the determined deflection direction, continuously horizontally deflecting emitting plate until the signal intensity of the first edge channel reaches the corresponding peak value.

6. The transceiver alignment method for LiDAR according to claim 5, controlling deflection of the receiving plate to adjust signal intensity of the second edge channel to a peak value is complemented by:
vertically deflecting the emitting plate by a second predetermined angle indicating a desired angular difference between the middle channel and the second edge channel in the vertical direction;
horizontally deflecting the emitting plate while monitoring real-time signal intensity variations of the second edge channel; and
determining a deflection direction for the emitting plate according to the real-time signal intensity variations of the second edge channel; and
according the determined deflection direction, continuously horizontally deflecting the emitting plate until the signal intensity of the second edge channel reaches the corresponding peak value.

7. A LiDAR, comprising:
a LiDAR optical engine, comprising:
a receiving plate, including a signal acquisition device;
an emitting plate corresponding to the receiving plate; and
a plurality of channels defined between the emitting plate and the receiving plate for transmitting laser beams, and signal intensity of the plurality of channels being acquired by the signal acquisition device;
an adjustment frame, the receiving plate and the emitting plate mounted on the adjustment frame, so as to drive the emitting plate or the receiving plate to move and/or rotate along a vertical direction and a horizontal direction;
a rotary table, the LiDAR optical engine being mounted on the rotary table; and
a controller, communicatively coupled with the rotary table, and drive the LiDAR optical engine to rotate along the direction vertical and the horizontal direction; the controller communicatively coupled with the LiDAR optical engine to control the LiDAR optical engine to perform channel selection and acquisition of channel signal intensity, wherein:
one of the plurality of the channels is selected as a middle channel and another two of the plurality of channels are respectively selected as a first edge channel and a second edge channel; wherein the middle channel is a channel corresponding to a laser beam emitted from a reference emission direction of the LiDAR, and the first edge channel and the second edge channel are symmetrically distributed on opposite sides of the middle channel in a vertical plane;
the receiving plate is defected to adjust signal intensity of the middle channel to a peak value;
the receiving plate is defected to adjust signal intensity of the first edge channel to a peak value;
the receiving plate is defected to adjust signal intensity of the second edge channel to a peak value; and
the emitting plate is defected to readjust signal intensity of the middle channel to a peak value;
the emitting plate is defected to readjust signal intensity of the first edge channel to a peak value; and
the emitting plate is defected to readjust signal intensity of the second edge channel to a peak value.

8. The LiDAR according to claim 7, wherein the signal acquisition device is a SiPM device.

9. The LiDAR according to claim 7, wherein the emitting plate and the receiving plate operatively coupled to the adjustment frame, and configured to be independently adjusted in the vertical direction and the horizontal direction.

10. The LiDAR according to claim 7, wherein the adjustment of the signal intensity of the middle channel to a peak value is implemented by:
deflecting the receiving plate along the horizontal direction until a horizontal direction signal intensity of the middle channel reaches to the corresponding peak value; and;
deflecting the receiving plate along a vertical direction until a vertical direction signal intensity of the middle channel reaches to the corresponding peak value.

11. The LiDAR according to claim 7, wherein the adjustment of the signal intensity of the first edge channel to a peak value is implemented by:
deflecting the receiving plate along a vertical direction by a first desired angle, the first desired angle indicating a desired angular difference between the middle channel and the first edge channel in the vertical plane;
deflecting the receiving plate along a horizontal direction while monitoring real-time signal intensity variations of the first edge channel;
determining a deflection direction for the receiving plate based on the signal intensity variation of the first edge channel; and
according to the determined deflection direction, continuously controlling the receiving plate deflecting along the horizontal direction until the signal intensity of the first edge channel reaches the corresponding peak value.

12. The LiDAR according to claim 11, wherein the adjustment of the second edge channel to a peak value is implemented by:
vertically deflecting the receiving plate based on a second desired angle indicating a desired angular difference between the middle channel and the second edge channel;
horizontally deflecting the receiving plate while monitoring real-time signal intensity variations of the second edge channel;
determining a deflection direction for the receiving plate according to the real-time signal intensity variations of the second edge channel; and
according the determined deflection direction, continuously horizontally deflecting the receiving plate until the signal intensity of the second edge channel reaches the corresponding peak value.

13. The LiDAR according to claim 11, wherein deflecting the receiving plate along a horizontal direction while monitoring real-time signal intensity variations of the first edge channel is implemented by:
vertically deflecting the emitting plate by a first predetermined angle indicating a desired angular difference between the middle channel and first edge channel;
horizontally deflecting the emitting plate while monitoring first edge channel real-time signal intensity variations;
determining a deflection direction for the emitting plate according to the real-time signal intensity variations of the first edge channel; and
according the determined deflection direction, continuously controlling emitting plate to deflect along the determined deflection direction until the signal intensity of the first edge channel reaches the corresponding peak value.

14. The LiDAR according to claim 12, wherein the adjustment of the signal intensity of the second edge channel to a peak value is implemented by::
vertically deflecting the emitting plate by a second predetermined angle indicating a desired angular difference between the middle channel and the second edge channel in the vertical direction;
horizontally deflecting the emitting plate while monitoring real-time signal intensity variations of the second edge channel; and
determining a deflection direction for the emitting plate according to the real-time signal intensity variations of the second edge channel; and
according the determined deflection direction, continuously horizontally deflecting the emitting plate until the signal intensity of the second edge channel reaches the corresponding peak value.

15. A transceiver alignment system, comprising:
a LiDAR, comprising:
a LiDAR optical engine, comprising:
a receiving plate, including a signal acquisition device;
an emitting plate corresponding to the receiving plate; and
a plurality of channels defined between the emitting plate and the receiving plate for transmitting laser beams, and signal intensity of the plurality of channels being acquired by the signal acquisition device;
an adjustment frame, the receiving plate and the emitting plate mounted on the adjustment frame, so as to drive the emitting plate or the receiving plate to move and/or rotate along a vertical direction and a horizontal direction;
a rotary table, LiDAR optical engine being mounted on the rotary table; and
a controller, communicatively coupled with the rotary table, and drive the LiDAR optical engine to rotate along vertical and horizontal directions; the controller communicatively coupled with the LiDAR optical engine to control the LiDAR optical engine to perform channel selection and acquisition of channel signal intensity, wherein:
one channel is selected as a middle channel and two channels are selected as a first edge channel and a second edge channel; wherein the middle channel is a channel corresponding to a laser beam emitted from a reference emission direction of the LiDAR, and the first edge channel and the second edge channel are symmetrically distributed on opposite sides of the middle channel in a vertical plane;
the receiving plate is defected to adjust signal intensity of the middle channel to a peak value;
the receiving plate is defected to adjust signal intensity of the first edge channel to a peak value;
the receiving plate is defected to adjust signal intensity of the second edge channel to a peak value; and
the emitting plate is defected to readjust signal intensity of the middle channel to a peak value;
the emitting plate is defected to readjust signal intensity of the first edge channel to a peak value; and
the emitting plate is defected to readjust signal intensity of the second edge channel to a peak value.

16. The transceiver alignment system according to claim 15, wherein the adjustment of the signal intensity of the middle channel to a peak value is implemented by:
deflecting the receiving plate along a horizontal direction until a horizontal direction signal intensity of the middle channel reaches to the corresponding peak value; and;
deflecting the receiving plate along a vertical direction until a vertical direction signal intensity of the middle channel reaches to the corresponding peak value.

17. The transceiver alignment system according to claim 15, wherein the adjustment of the signal intensity of the first edge channel to a peak value is implemented by:
deflecting the receiving plate along a vertical direction by a first desired angle, the first desired angle indicating a desired angular difference between the middle channel and the first edge channel in the vertical plane;
deflecting the receiving plate along a horizontal direction while monitoring real-time signal intensity variations of the first edge channel;
determining a deflection direction for the receiving plate based on the signal intensity variation of the first edge channel; and
according to the determined deflection direction, continuously controlling the receiving plate deflecting along the horizontal direction until the signal intensity of the first edge channel reaches the corresponding peak value.

18. The transceiver alignment system according to claim 17, wherein the adjustment of the signal intensity of the second edge channel to a peak value s is implemented by:
vertically deflecting the receiving plate based on a second desired angle indicating a desired angular difference between the middle channel and the second edge channel;
horizontally deflecting the receiving plate while monitoring real-time signal intensity variations of the second edge channel;
determining a deflection direction for the receiving plate according to the real-time signal intensity variations of the second edge channel; and
according the determined deflection direction, continuously horizontally deflecting the receiving plate until the signal intensity of the second edge channel reaches the corresponding peak value.

19. The transceiver alignment system according to claim 15, wherein deflecting the receiving plate along a horizontal direction while monitoring real-time signal intensity variations of the first edge channel is implemented by:
vertically deflecting the emitting plate by a first predetermined angle indicating a desired angular difference between the middle channel and first edge channel;
horizontally deflecting the emitting plate while monitoring first edge channel real-time signal intensity variations;
determining a deflection direction for the emitting plate according to the real-time signal intensity variations of the first edge channel; and
according the determined deflection direction, continuously horizontally deflecting emitting plate until the signal intensity of the first edge channel reaches the corresponding peak value.

20. The transceiver alignment system according to claim 16, wherein the adjustment of the signal intensity of the second edge channel to a peak value is implemented by:
vertically deflecting the emitting plate by a second predetermined angle indicating a desired angular difference between the middle channel and the second edge channel in the vertical direction;
horizontally deflecting the emitting plate while monitoring real-time signal intensity variations of the second edge channel; and
determining a deflection direction for the emitting plate according to the real-time signal intensity variations of the second edge channel; and
according the determined deflection direction, continuously horizontally deflecting the emitting plate until the signal intensity of the second edge channel reaches the corresponding peak value.
